(19) United States
(12) Patent Application Publication
(10) Pub. No.: US 2005/0086245 A1
(43) Pub. Date: Apr. 21, 2005

(54) Architecture for a hardware database management system

(75) Inventors: Victor A. Bennett, Rockwall, TX (US); Frederick R. Petersen, Dallas, TX (US); Gerald R. Platz, Heath, TX (US)

Correspondence Address: DLA PIPER RUDNICK GRAY CARY US, LLP, 2000 UNIVERSITY AVENUE, E. PALO ALTO, CA, 94303-2248, US

(73) Assignee: Calpont Corporation, Rockwall, TX (US)

(21) Appl. No.: 10/686,225

(22) Filed: Oct. 15, 2003

(51) Int. Cl. G06F 17/00

(52) U.S. Cl. 707/101

(57) ABSTRACT

An architecture for a hardware database management system is described. A data flow engine is connected to memory storing the information making up a database or databases. The data flow engine is formed by a parser, an execution tree engine and a graph engine. The parser takes standardized database statements and converts those statements into a set of executable instructions and associated data objects. The executable instructions and data objects are then sent to the execution tree engine where an execution tree is created, the execution tree forming the order of execution for the executable instructions. The graph engine receives those executable instructions from the execution tree engine that require access to the database in memory and manipulates the information in the database as required by the executable instructions for implementing the standardized database statement.

### TECHNICAL FIELD OF THE INVENTION

The present invention relates to database structures and database management systems. Specifically, the present invention relates to an architecture for a hardware database management system.

### BACKGROUND OF THE INVENTION

The term database has been used in an almost infinite number of ways. The most common meaning of the term, however, is a collection of data stored in an organized fashion. Databases have been one of the fundamental applications of computers since they were introduced as a business tool. Databases exist in a variety of formats including hierarchical, relational, and object oriented. The most well known of these are clearly the relational databases, such as those sold by Oracle, IBM and Microsoft. Relational databases were first introduced in 1970 and have evolved since then. The relational model represents data in the form of two-dimensional tables, each table representing some particular piece of the information stored. A relational database is, in the logical view, a collection of two-dimensional tables or arrays.

Though the relational database is the typical database in use today, an object oriented database format, XML, is gaining favor because of its applicability to network, or web, services and information. Objected oriented databases are organized in tree structures instead of the flat arrays used in relational database structures. Databases themselves are only a collection of information organized and stored in a particular format, such as relational or object oriented. In order to retrieve and use the information in the database, a database management system (“DBMS”) is required to manipulate the database.

Traditional databases suffer from some inherent flaws. Although continuing improvements in server hardware and processor power can work to improve database performance, as a general rule databases are still slow. The speeds of the databases are limited by general purpose processors running large and complex programs, and the access times to the disk arrays. Nearly all advances in recent microprocessor performance have tried to decrease the time it takes to access essential code and data. Unfortunately, for database performance, it does not matter how fast a processor can execute internal cycles if, as is the case with database management systems, the primary application is reading or modifying large and varied numbers of locations in memory.

Also, no matter how many or how fast the processors used for databases, the processors are still general purpose an must use a software application as well as an operating system. This architecture requires multiple accesses of software code as well as operating system functions, thereby taking enormous amounts of processor time that are not devoted to memory access, the primary function of the database management system.

Beyond server and processor technology, large databases are limited by the rotating disk arrays on which the actual data is stored. While many attempts have been made at great expense to accelerate database performance by caching data in solid state memory such as dynamic random access memory, (DRAM), unless the entire database is stored in the DRAM the randomness of data access in database management system means misses from the data stored in cache will consume an enormous amount of resources and significantly affect performance. Further, rotating disk arrays require significant time and money be spent to continually optimize the disk arrays to keep their performance from degrading as data becomes fragmented.

All of this results in database management systems being very expensive to acquire and maintain. The primary cost associated with database management systems are initial and recurring licensing costs for the database management programs and applications. The companies licensing the database software have constructed a cost structure that charges yearly license fees for each processor in every application and DBMS server running the software. So while the DBMS is very scalable the cost of maintaining the database also increased proportionally. Also, because of the nature of the current database management systems, once a customer has chosen a database vendor, the customer is for all practical purposes tied to that vendor. Because of the extreme cost in both time, expense and risk to the data, changing database programs is very difficult, this is what allows the database vendors to charge the very large yearly licensing fees that currently standard practice for the industry.

The reason that changing databases is such an expensive problem are the proprietary implementations of standardized database languages. While all major database programs being sold today are relational database products based on a standard called Standard Query Language, or SQL, each of the database vendors has implemented the standard slightly differently resulting, for all practical purposes, in incompatible products. Also, because the data is stored in relational tables in order to accommodate new standards and technology such as Extensible Mark-up Language (“XML”) which is not relational, large and slow software programs must be used to translate the XML into a form understandable by the relational products, or a completely separate database management system must be created, deployed and maintained for the new XML database.

Accordingly, what is needed is a database management system with improved performance over traditional databases and which is protocol agnostic.

### SUMMARY OF THE INVENTION

The present invention provides for a database management engine implemented entirely in hardware. The database itself is stored in random access memory (“RAM”) and is accessed using a special purpose processor referred to as the data flow engine. The data flow engine parses standard SQL and XML database commands and operations into machine instructions that are executable by the data flow engine. These instructions allow the data flow engine to store, retrieve, change and delete data in the database. The data flow engine is part of an engine card which also contains a microprocessor that performs processing functions for the data flow engine and converts incoming data into statements formatted for the data flow engine. The engine card is connected to a host processor which manages the user interfaces to the data base management engine.

The database management system implemented by the data flow engine is formed by a parser, an execution tree engine and a graph engine connected to the database stored in RAM. The parser, or parsing engine, is used to take standardized database statements, such as an SQL or XML statement and create executable instructions from the statement along with the associated data objects. The executable instructions and their associated data objects are then sent to an execution engine, also referred to as an execution tree processor, where the executable instructions forming the statement are used to create an execution tree, which represents the order of execution of the executable instructions based on the interdependency of the executable instructions. The executable instructions are then executed as prescribed by the execution tree. Instructions that require access to the database are sent to the graph engine. The graph engine is operable to manipulate, such as reading, writing and altering, the information in the database. The graph engine is also operable to create and maintain the data structure used to store the information contained in the database.

In addition to creating the execution trees, the execution engine maintains the integrity of the data in the database, and controls access to restricted information in the database. The execution engine may also perform functions that do not require access to the information in the database, and may also call functions or routines outside of the data flow engine, such as a routine in the external microprocessor, or in other devices connected to the network.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art will appreciate that they can readily use the disclosed conception and specific embodiment as a basis for designing or modifying other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a prior art database topology diagram;

FIG. 2 illustrates a database topology constructed according to the principles of the present invention, including a block diagram of a database management engine in accordance with the principles of the present invention;

FIG. 3 illustrates an alternative database topology constructed according to the principles of the present invention;

FIG. 4 illustrates a block diagram of an embodiment of the database management engine from FIG. 3;

FIG. 5 illustrates a block diagram of an embodiment of a data flow engine from FIG. 4; and

FIG. 6 illustrates a block diagram of an embodiment of a database management engine, according to the present invention, which is compatible with a compact PCI form factor.

### DETAILED DESCRIPTION OF THE DRAWINGS

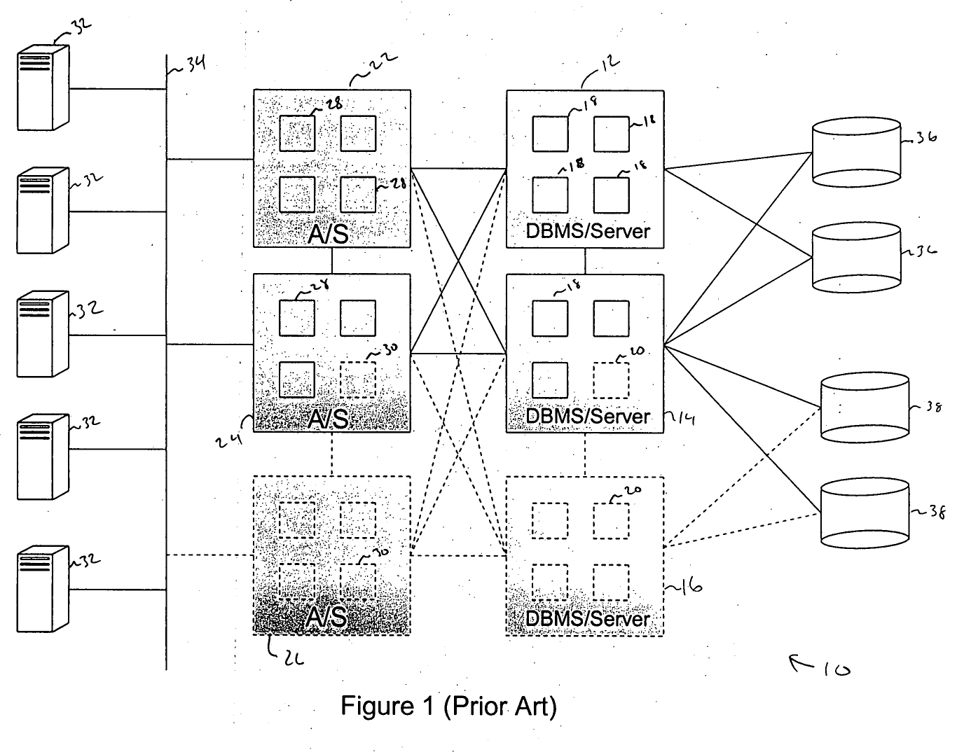

Referring now to FIG. 1, a diagram of a prior art networked database management system 10 is shown. The prior art database management system (“DBMS”) is implemented using general purpose DBMS servers 12 and 14, such as those made by Sun, IBM, and Dell, running database programs such as Oracle, DB2, and SQL Server. The programs run on one or more general purpose microprocessors 18 in the DBMS servers 12 and 14. The data in the database is stored using arrays of disk drives 36 and 38. Small portions of the overall database can be cached in the servers 12 and 14 to aid performance of database management system 10 since the access time to read and write to disk arrays 36 and 38 can slow performance considerably.

In addition to the DBMS servers 12 and 14 the database management system 10 can include application servers 22 and 24 that run in conjunction with the DBMS servers 12 and 14. While the DBMS servers manage the essential database functions such as storing, retrieving, changing, and deleting the data contained in disk arrays 36 and 38, the application servers run programs that work with the DBMS to perform tasks such as data mining, pattern finding, trend analysis and the like. The application servers 22 and 24 are also general purpose servers with general purpose microprocessors 28 running the application programs.

The database management system 10 is accessed over network 34 by workstations 32 which represent the users of the database. The users send instructions to the application servers which then access the DBMS servers to get the appropriate response for the users. Because the database management system 10 is accessed via a network the users and the database, and even the individual elements of the database do not have to be co-located.

One of the advantages of database management system 10 is its scalability. The database, database management system, and application servers can be easily scaled in response to an increase number of users, increased data in the database itself or more intensive applications running on the system. The system may be scaled by adding processors such has processors 10 and 30 to the existing application servers, and DBMS servers, or additional application servers and DBMS servers 26 and 16, respectively, can be added to handle any increased loads. Additionally, new disk arrays can be added to allow for an increase in the size of the actual database, or databases, being stored.

While database management system 10 can work with very large databases and can scale easily to meet differing user requirements, it does suffer from a multitude of well know problems. Although continuing improvements in server hardware and processor power can work to improve database performance, as a general rule databases, such as those constructed as described with respect to database management system 10 are still slow. The speeds of the databases are limited by general purpose processors running large and complex programs, and the access times to the disk arrays, such as disk arrays 36 and 38. Additionally, significant time and money must be spent to continually optimize the disk arrays to keep their performance from degrading as data becomes fragmented.

Additionally, database management system 10 is very expensive to acquire and maintain. The primary cost associated with database management system 10 is initial and recurring licensing costs for the database management programs and applications. The companies licensing the database software have constructed a cost structure that charges yearly license fees for each processor in every application and DBMS server running the software. So while the DBMS is very scalable the cost of maintaining the database also increased proportionally. Also, because of the nature of the current database management systems, once a customer has chosen a database vendor, the customer is for all practical purposes tied to that vendor. Because of the extreme cost in both time, expense and risk to the data, changing database programs is very difficult, thereby allowing database vendors to charge very large yearly licensing and maintenance fees.

While all major database programs being sold today are relational database products based on a standard called Standard Query Language, or SQL, each of the database vendors has implemented the standard slightly differently resulting, for all practical purposes, in incompatible products. The proprietary nature of each large DBMS prevents customers from easily switching to a new vendor. Also, because the data is stored in relational tables in order to accommodate new standards and technology such as Extended Mark-up Language (“XML”) which is not relational, large and slow software programs must be used to translate the XML into a form understandable by the relational products, or a completely separate database management system must be created, deployed and maintained for the new XML database.

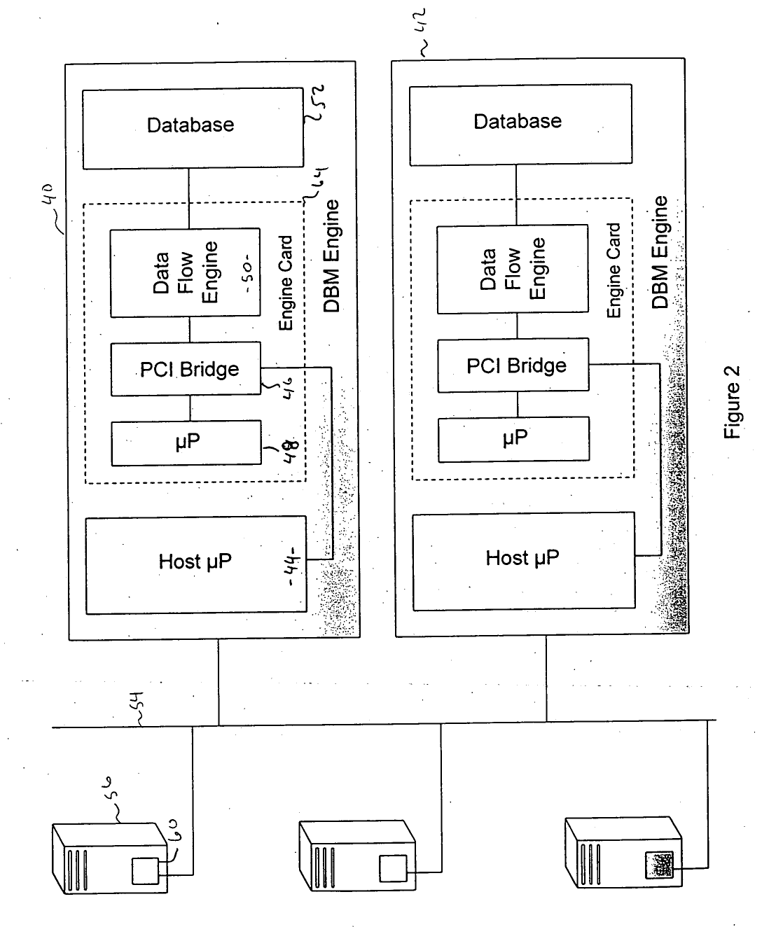

Referring now to FIG. 2, a database management system that addresses the deficiencies of the database management system in FIG. 1 is described. Database management (“DBM”) engine 40 replaces database management system 10 from FIG. 1. DBM engine 40 is a complete database management system implemented in special purpose hardware. By implementing the database management system entirely in hardware, DBM engine 40 overcomes many of the problems traditionally associated with database management systems. Not only is the database management aspect implemented in hardware, but the database, shown here as database 52, itself is stored in random access memory (“RAM”) allowing for very fast storage, retrieval, alteration and deletion of the data itself. Further, DBM engine 40 stores information in database 52 in a unique data structure that is protocol agnostic, meaning that DBM engine 40 is able to implement both SQL and XML databases in hardware using the same unique data structure in database 52.

DBM engine 40 can be configured to communicate with workstation 56 over network 54. A software program and/or driver 60 is installed on workstation 60 to manage communication with DBM engine 40 and possibly to perform some processing on the information exchanged between workstation 56 and DBM engine 40. DBM engine 40 is designed to be transparent to the user using workstation 56. In other words, the user, whether they have been trained on Oracle, IBM DB2, Microsoft SQL Server, or some other database, will be able to access DBM engine 40 and database 52 using substantially the same form of SQL or XML that are already familiar with. This allows existing databases to be transitioned to DBM engine 40 with only minimal training of existing users.

DBM engine 40 is comprised of engine card 64, host microprocessor 44 and database 52. Connections with DBM engine 40 are verified by host microprocessor 44. Host microprocessor 44 establishes connections with workstations 56 using standard network database protocols such as ODBC, or JDBC. Host microprocessor 44, in addition to managing access, requests and responses to DBM engine 40, can also be used to run applications, perform some initial processing on queries to the database and other processing overhead that does not need to be performed by engine card 64.

Engine card 64 is a hardware implementation of a database management system such as those implemented in software programs by Oracle, IBM and Microsoft. Engine card 64 includes a PCI bridge 46 which is used to communicate with host microprocessor 44, and to pass information between microprocessor 48 and data flow engine 50. Microprocessor 48 places the requests from host microprocessor 44 into the proper format for data flow engine 50, queues requests for the data flow engine, and handles processing tasks that cannot be performed by data flow engine 50. Microprocessor 48 communicates with data flow engine 50 through PCI bridge 46, and all information in and out of data flow engine 50 passes through microprocessor 48.

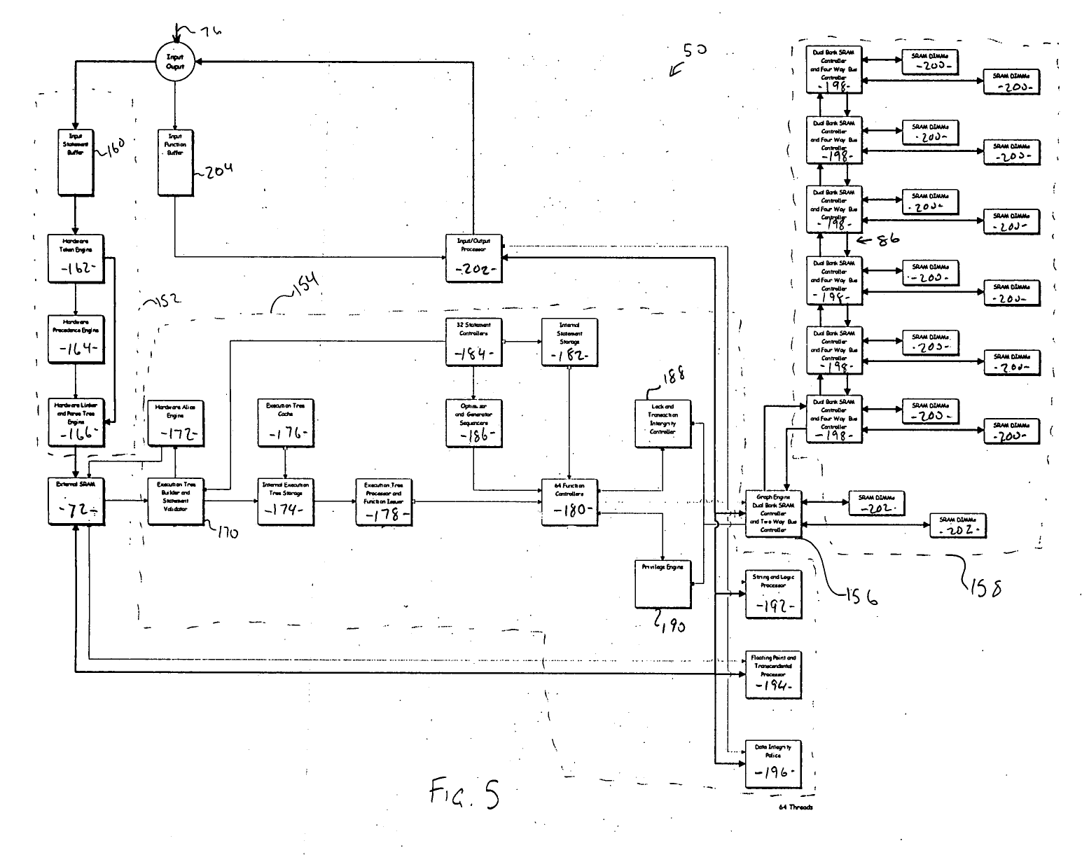

Data flow engine, which is described in greater detail with reference to FIG. 5, is a special purpose processor optimized to process database functions. Data flow engine can be implemented as either a field programmable gate array (“FPGA”) or as an application specific integrated circuit (“ASIC”). Data flow engine 50 is the interface with database 52. Data flow engine is responsible for storing, retrieving, changing and deleting information in database 52. Because all of the database functionality is implemented directly in hardware in data flow engine 50, there is no need for the software database management programs. This eliminates initial and recurring license fees currently associated with database management systems.

Also, because the database management system is all in hardware and because database 52 is stored entirely in RAM, the time required to process a request in the database is significantly faster than in current database management systems. With current database management systems requests must pass back and forth between the various levels of software, such as the program itself and the operating system, as well as several levels of hardware, which include the processor local RAM, input/output processors, external disk arrays and the like. Because requests must pass back and forth between these various software levels and hardware devices, responses from the database management system to requests is very time consuming and resource intensive. DBM 40 engine, on the other hand, passes requests straight to the data flow engine 50, which then access memory directly, processes the response and returns the response, all at machine level without have to pass through an operating system and software program and without having to access and wait on disk arrays. The approach of the present invention is orders of magnitude faster than current implementations of database management systems.

DBM engine 40 is also readily scalable, as with current database management systems. In order to accommodate more users or larger databases the RAM associated with database 52 can be increased, and/or additional DBM engines, such as DBM engine 42, can be added to the network. Being able to scale the database management system of the current invention, by sampling adding additional memory or DBM engines allows a user to only purchase the system required for their current needs. As those needs change, additional equipment can be purchased to keep pace with growth requirements. Without the requirement of the database management programs and additional processors, as discussed with reference to FIG. 1, scaling a database management system in accordance with the present invention would not require additional software licenses.

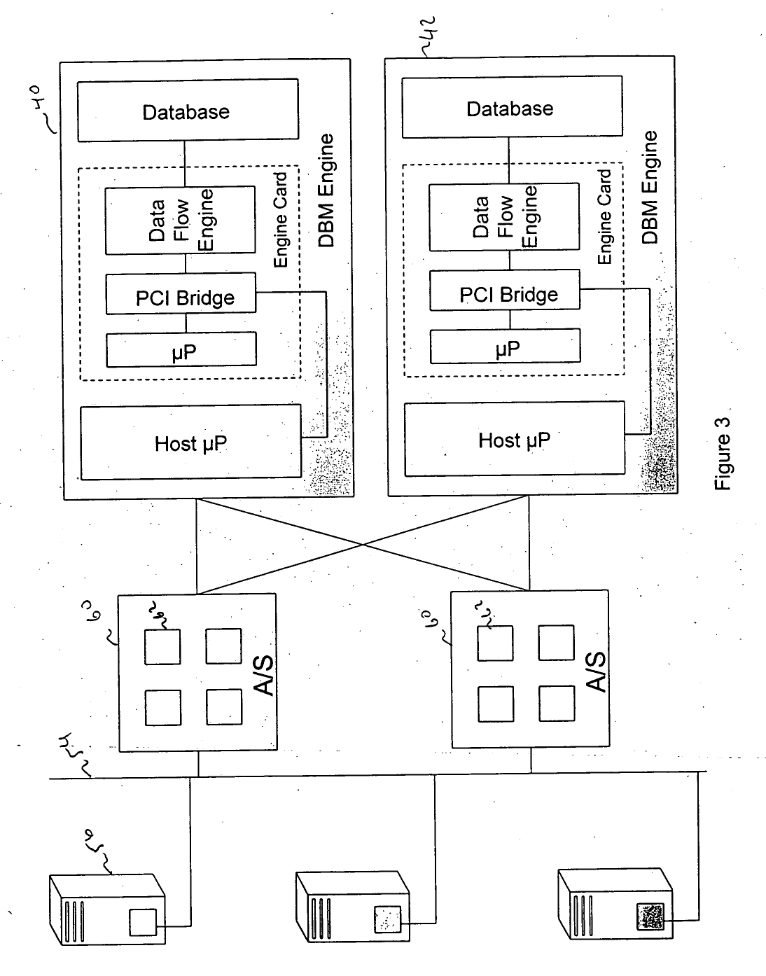

Referring now to FIG. 3, a database management system according to the present invention is shown which incorporates existing application servers 60 with processors 62 to perform more complex applications, such as data mining, pattern identification and trend analysis. DBM engines 40 and 42 still provide the database and the database management function, but application servers 60 have been added to allow for complex applications to be run without consuming the resources of DBM engines 40 and 42. Additionally, existing database hardware can be used as application servers in the database management system of the present invention so that existing resources are not wasted when an existing database is converted to the database management system of the present invention. As with the database management system shown in FIG. 1, the users, represented by workstation 56, communicate over network 54 with applications servers 60. Application servers 60 then access the resources of DBM engines 40 and 42 and pass the responses back to workstations 56.

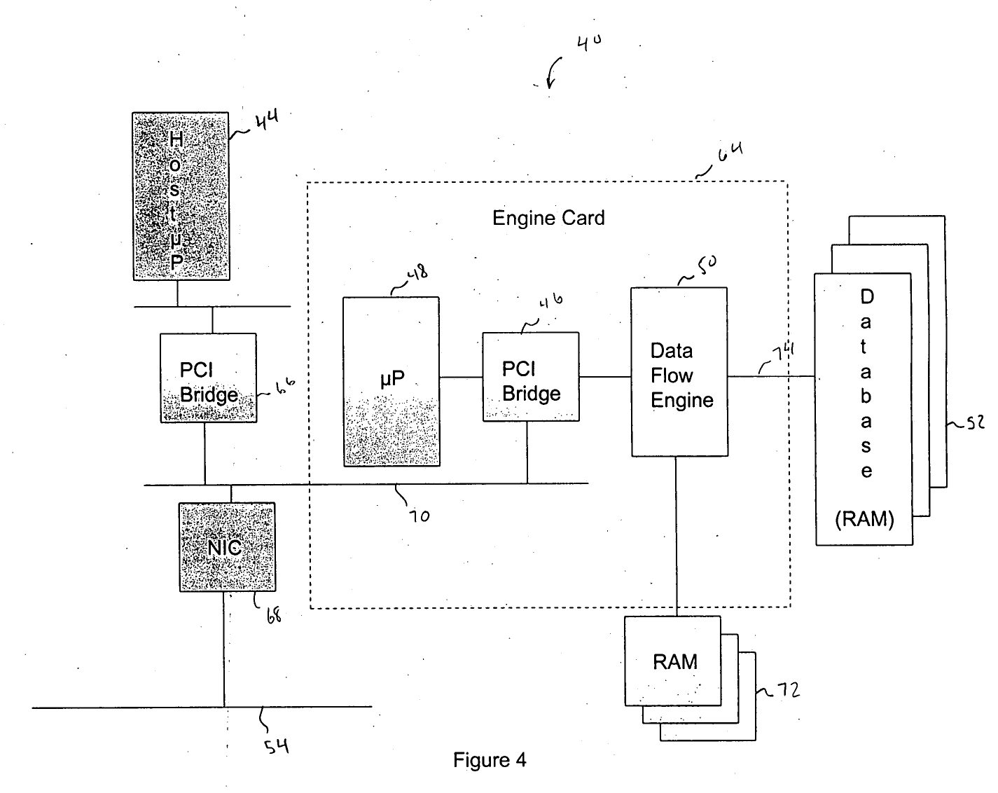

Referring now to FIG. 4, the DBM engine 40 is shown in greater detail. DBM engine 40 is in communication with network 54 through network interface card (“NIC”) 68. NIC 68 is then connected to PCI bus 70. Requests to and responses from DBM engine 40 are passed by NIC 68 through host PCI bridge 66 to host microprocessor 44. As stated with respect to FIG. 2, host microprocessor 44 is used to track and authenticate users, pass requests and responses using standard database communication drivers, multiplex and demultiplex requests and responses, and to help format requests and responses for processing by data flow engine 50. Host microprocessor 44 communicates with microprocessor 48 on engine card 64 through PCI bridge 46. Host microprocessor sends multiplexed data to microprocessor 48 in blocks. Blocks in the current embodiment are 64 kbytes long.

Microprocessor 48 receives the requests from host microprocessor 44 and passes data flow engine the requests in the form of a statement that in the current embodiment of the present invention is 32 characters long. Data processing engine 50 takes the statements from microprocessor 48 and performs the requested functions on the database. The operation of data flow engine 50 will be discussed in greater detail with reference to FIG. 5. Data flow engine 50 accesses database 52 using bus 74.

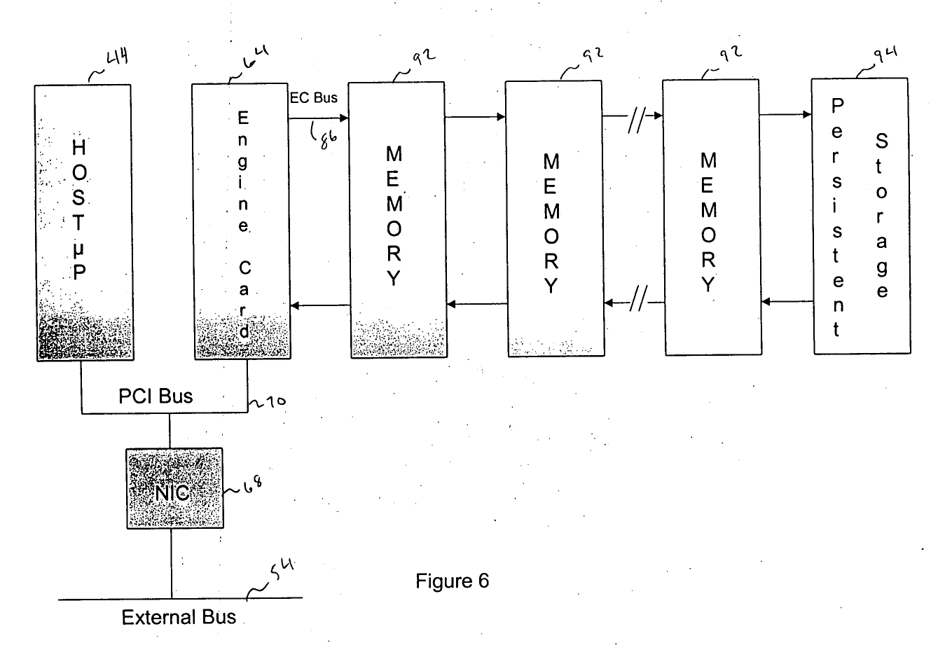

As stated, database 52 is stored in RAM instead of on disk arrays as with traditional databases. This allows for much quicker access times than with a traditional database. Also, as stated the data in database 52 is protocol independent. This allows DBM engine 40 to store object oriented, or hierarchical information in the same database as relational data. As opposed to storing data in the table format used by the relational databases, data flow engine 50 stores data in database 52 in a graph structure where each entry in the graph stores information and/or information about subsequent entries. The graph structure of the database provides a means for storing the data efficiently so that much more information can be stored than would be contained in a comparable disk array using a relation model. One such structure for a database, which along with other, broader, graph structures maybe used in the present invention, is described in U.S. Pat. No. 6,185,554 to Bennett, which is hereby incorporated by reference. Database 52 can contain multiple banks of RAM and that RAM can be co-located with data flow engine 50 or can be distributed on an external bus, as will be shown in FIG. 6.

In addition to database 52, data flow engine is connected to working memory 72. Working memory 72 is also RAM memory, and is used to store information such as pointers, status, and other information that is used by data flow engine 50 when traversing the database.

Referring now to FIG. 5, data flow engine 50 is discussed in greater detail. Data flow engine 50 is formed by parser 152, execution tree engine 154, and graph engine 156. Parser 152 acts to break down statements, such as SQL statements or XML statements, into executable instructions and data objects associated with these units. The parser takes each new statement and identifies the operators and their associated data objects. For example, in the SQL statement SELECT DATA FROM TABLE WHERE DATA2=VALUE, the operators SELECT, FROM, WHERE, and =are identified as operators, while DATA, TABLE, DATA2, and VALUE, are identified as data object. The operators are then converted into executable instructions while the data objects are associated with their corresponding operator and stored in memory. When the parser is finished with a particular statement, a series of executable instructions and links to their associated data are sent to execution tree engine 154 for further processing.

Parser 152 is formed by input statement buffer 160, hardware token engine 162, hardware precedence engine 164, and hardware linker and parse tree engine 166. Statements are sent and received over PCI bus 76. New statements are sent to parser 152 where they are buffered and queued by input statement buffer 160. From input statement buffer 160, statements are sent to hardware token engine 162 where each element of a statement is compared against a table of operators. If an element in a statement matches an entry in the table it is identified as an operator and an executable instruction, which can be in the form of a binary code, is substituted for the operator. Elements that don't match any entries in the table are identified as data objects, associated with the proper operator, and stored in external memory 72.

The executable instructions generated by hardware token engine 162 are then sent to hardware precedence engine 164. Hardware precedence engine 164 examines each of the executable instructions and links them according to the order that they must be executed in. For example the equation A+B*(C+D), the hardware precedence engine recognizes that the parenthetical statement (C+D) must be executed first, then the result multiplied by B before that result is then added to A. Once the correct precedence has been established, the executable instructions are sent to hardware linker and parse tree engine 166, which manages external working memory 72. Hardware linker and parse tree engine 166 stores the executable instructions in external working memory 72 when all the executable instructions and data objects are ready to be processed.

Once the executable instructions and data objects are ready to be processed, execution tree builder 170 first validates that the executable instructions are proper and valid. Execution tree engine 170 then takes the executable instructions forming a statement and builds an execution tree, the execution tree representing the manner in which the individual executable instructions will be processed in order to process the entire statement represented by the executable instructions. An example of the execution tree for the SQL statement SELECT DATA FROM TABLE WHERE DATA2=VALUE can be represented as:

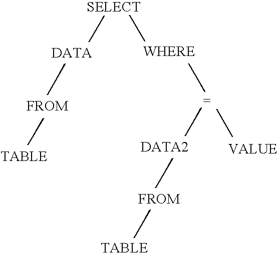

The execution tree once assembled would be executed from the elements without dependencies toward the elements with the most dependencies, or from the bottom up to the top in the example shown. Branches without dependencies on other branches can be executed in parallel to make handling of the statement more efficient. For example, the left and right branches of the example shown do not have any interdependencies and could be executed in parallel. Hardware alias engine 172 keeps track of, and provides the mapping for, any table aliases that may exist in the database.

Execution tree storage 174 and execution tree cache 176 buffer and store the execution trees and any related information that may be needed by the execution trees. Execution tree processor 178 then takes the execution trees and identifies those elements in the trees that do not have any interdependencies and schedules those elements of the execution tree for processing. Each element contains within it a pointer pointing to the location in memory where the result of its function should be stored. When each element is finished with its processing and its result has been stored in the appropriate memory location, that element is removed from the tree and the next element is then tagged as having no interdependencies and it is scheduled for processing by execution tree engine 178. Execution tree engine takes the next element for processing and waits for a thread in function controller 180 to open. Additionally, elements that common across the execution tree can be assigned tags. These tags can be used to share the results of common elements across the instructions of the execution tree. For example, if VALUE 1+VALUE2 is repeated in multiple places across the same statement, instead of reexecuting or recalculating VALUE1+VALUE2 each time it appears, the result of VALUE1+VALUE2 is assigned a tag which is inserted into the execution tree for each instance of VALUE1+VALUE2. The tag points to the result of VALUE1+VALUE2 from its first calculation and uses it in subsequent instances of the element saving the processing time required to execute the subsequent instruction.

Function controller 180, in conjunction with statement storage 182, statement controllers 184, and optimizer and sequencers 186 then act to process the individual executable instructions, with their associated data objects. Optimizer and sequencers 186 act to continuously monitor the processing of each statement and to optimize the execution tree for the most efficient processing. Optimizer and sequencer 186 also acts to tell function controller 180 when a particular executable instruction, and any associated data objects, when to send the elements to any of the graph engine 156, string processor 192, or floating point processor 194.

Data integrity engine 196 acts to enforce database constraints such as enforcing that there are no null values in the data base, that there are no duplicates, and that corresponding values match. Privilege engine 190 controls access to information in the database that has restricted access, or is only viewable by a subset of users. Transaction integrity controller 188 provides commit and rollback functions for the database, and insures read consistency for the information in the database. Commit and rollback functions occur when information in the database is being altered. The information that is being changed is kept in parallel with the original information and until the changes are committed, other users of the information see the old data, thereby providing read consistency. Changes that are not committed would be rolled back, or removed from the database.

Execution engine 154 can also go outside of data flow engine 50 to either access data associated with a separate data flow engine, or to access functions or routines outside the data flow engine, such as routines run in microprocessor 48 from FIG. 4. In this case the data request, or function or routine call is sent by execution tree engine 154 to input/output processor 202. Input/output processor 202 then sends the information to microprocessor 48 from FIG. 4 over PCI bus 76 for processing or routing. Responses to the data requests, or function or routine calls are received on PCI bus 76 and are sent to input function buffer 204 and then back to input/output processor 202 where the response is then returned to execution tree engine 154 for further processing.

Executable instructions or function calls that require access to the entries in the database are sent to graph engine 156. Graph engine 156 provides the mechanisms to read from, write to, and alter the database. The database itself is stored in database memory 158 which is preferably random access memory, but could be any type of memory including flash or rotating memory. In order to improve performance as well as memory usage, the information contained in the database is stored in memory differently than traditional databases. Traditional databases, such as those based on the SQL standard, are relational in nature and store the information in the databases in the form of related two-dimensional tables, each table formed by a series of columns and rows. The relational model has existed for decades and is the basis for nearly all large databases. Other models have begun to gain popularity for particular applications, the most notable of which is XML which is used for web services and unstructured data. Data in XML is stored in a hierarchical format which can also be referred to as a tree structure.

The database of the present invention stores information in a data structure unlike any other database. The present invention uses a graph structure to store information. In the well known hierarchical tree structure there exists a root and then various nodes extending along branches from the root. In order to find any particular node in the tree one must begin at the root and traverse the correct branches to ultimately arrive at the desired node. Graphs, on the other hand, are a series of nodes, or vertices, connected by arcs, or edges. Unlike a tree, a graph need not have a specific root and unique branches. Also unlike a tree, vertices in a graph can have arcs that merge into other trees or arcs that loop back into the same tree.

In the case of the database of the present invention the vertices are the information represented in the database as well as certain properties about that information and the arcs that connect that vertex to other vertices. Graph engine 156 is used to construct, alter and traverse the graphs that store the information contained in the database. Graph engine 156 takes the executable instructions that require information from, or changes to, the database and provides the mechanism for creating new vertices and arcs, altering or deleting existing vertices or arcs, and reading the information from the vertices requested by the statement being processed.

The graphs containing database 158 are stored in memory 200 and 202. Memory 202 is local to graph engine 156 and can be accessed directly. To increase the memory available for storing database 158, graph engine 156 can be connected to a ring of memory controllers 198. Memory controllers 198 form a ring bus 86 that allows database 158 to be stored in any number of memory modules 200. Data is passed around the ring bus 86 of memory controllers 198 until the memory controller recognizes the address space as belonging to the memory it controls. The memory is then accessed and the result passed around the ring bus until it is returned to graph engine 156.

Referring now to FIG. 6, an embodiment of the present invention implemented in accordance with the compact PCI architecture is described. The database management system works exactly as described with reference to FIGS. 2 through 5. The use of the compact PCI form factor allows additional memory cards to be connected on external cell bus 86. As many memory cards 92 may be connected to external cell bus 86 as are available in the compact PCI chassis. In addition to the memory cards 92, a persistent storage medium may be connected to the external cell bus 86 to allow a non-volatile version of the database to be maintained in parallel with the database stored in RAM. The persistent storage medium may be disk drives or may be a static device such as flash memory.

The microprocessors described with reference to FIGS. 2 through 4 could be any suitable microprocessor including the PowerPC line of microprocessors from Motorola, Inc., or the X86 or Pentium line of microprocessors available from Intel Corporation. Additionally, the PCI bridges and network interface cards are well known parts readily available. Although particular references have been made to specific protocols, implementations and materials, those skilled in the art should understand that the network processing system, the policy gateway can function independent of protocol, and in a variety of different implementations without departing from the scope of the invention in its broadest form.

1. A hardware database management system for managing and manipulating information stored in a database using standardized database statement, the hardware database management system comprising:
a parser receiving the standardized database statements and converting the standardized database statements into executable instructions and data objects;
an execution tree processor connected to the parse and receiving the executable instructions from the parser, the execution tree processor creating execution trees from the executable instructions and schedules the execution trees for execution; and
a graph engine connected to the execution tree processor, the graph engine operable to manipulate the database as required by the executable instructions.

2. The hardware database management system of claim 1 wherein the information in the database is represented in memory in the form of graphs.

3. The hardware database management system of claim 1 wherein the execution tree processor is further operable to validate the executable instructions received from the parser.

4. The hardware database management system of claim 1 wherein the execution tree processor is further operable to ensure data integrity in the database and to control access to restricted information in the database.

5. The hardware database management system of claim 1 wherein the execution tree processor further comprises at least one function engine, the function engine operable to perform functions in accordance with the executable instructions.

6. The hardware database management system of claim 1 wherein the standardized database statements are Structured Query Language statements.

7. The hardware database management system of claim 1 wherein the execution tree processor is further operable to continually optimize the execution trees.

8. The hardware database management system of claim 1 wherein the manipulation of the database by the graph engine includes reading information from the database, writing information into the database and altering information in the database.

9. The hardware database management system of claim 1 wherein the execution tree processor may call routines from an external microprocessor.

10. A data flow engine for implementing a database management system in hardware, the database management system operable to process standardized database statements against a database of information, the data flow processor comprising:
a parsing engine operable to convert the standardized database statements into executable instructions; and
an execution engine receiving the executable instructions from the parsing engine, the execution engine validating the executable instructions, and building execution trees to schedule the executable instructions, the execution engine further operable to ensure the integrity of the information in the database and to control access to restricted information in the database; and
a graph engine operable to execute the executable instructions that require the manipulation of the information in the database.

11. The hardware database management system of claim 10 wherein the information in the database is stored in random access memory accessible to the graph engine.

12. The hardware database management system of claim 10 wherein the database is represented in memory attached to multiple data flow engines, and wherein the data flow engine may access information by sending requests to a second data flow engine.

13. The hardware database management system of claim 10 wherein the execution tree processor further comprises at least one function engine, the function engine operable to perform functions in accordance with the executable instructions.

14. The hardware database management system of claim 10 wherein the standardized database statements are Structured Query Language statements.

15. The hardware database management system of claim 10 wherein the standardized database statements are Xtensible Markup Language.

16. The hardware database management system of claim 10 wherein the execution tree processor is further operable to continually optimize the execution trees.

17. The hardware database management system of claim 10 wherein the manipulation of the database by the graph engine includes reading information from the database, writing information into the database and altering information in the database.

18. The hardware database management system of claim 10 wherein the execution tree processor may call routines from an external microprocessor.
